(19) United States
(12) Patent Application Publication
(10) Pub. No.: US 2010/0140462 A1
(43) Pub. Date: Jun. 10, 2010

(54) System and Method for Real-Time Measurement of Sail Conditions and Dynamics

(75) Inventors: Thomas Farrell, Dublin (IE); John Levins, Dublin (IE); Michael Todd, Dublin (IE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: INTUNE TECHNOLOGIES LIMITED, Dublin (IE)

(21) Appl. No.: 12/515,732

(22) PCT Filed: Nov. 20, 2007
(86) PCT No.: PCT/IE07/00113

§ 371 Date: Feb. 1, 2010

(30) Foreign Application Priority Data
Nov. 20, 2006 (IE) 2006/0835

(51) Int. Cl. G01J 1/42; G02B 6/00; G01K 11/32; G01M 11/08

(52) U.S. Cl. 250/227.14; 385/12; 374/161; 374/E11.016

(57) ABSTRACT

The invention provides an optical measurement system and method for monitoring the condition of a sail, the system comprising: an optical interrogation unit that produces and receives an optical signal; and an optical fibre network that interconnects the interrogation unit with a plurality of optical sensors in communication with the sail, wherein the sensors are mounted onto the sail. The optical system measures parameters of the sail, from which shape, integrity and overall conditions of the sail can be calculated in real-time.

### FIELD OF THE INVENTION

The invention relates to optical sensing, particularly to an optical method and system for measuring the temperature and strain profile of a sail on a sailing vessel, and suitable for all sailing environments.

### BACKGROUND TO THE INVENTION

Accurate measurement of the temperature and strain profile and shape of a sail both in controlled and racing environments would offer valuable insight into sail design and performance. The complex dynamics of the sail as well as the harsh environment on the water present two notable challenges.

The first relates to devising a suitable technological solution that can survive the sailing conditions. To withstand the punishment typically experienced by a sail, the sensing solution must be robust enough to cope with violent flapping (“flogging”), rough and indiscriminate handling, folding, as well as the corrosive nature of salt and water. Further, an instrument is needed on board the vessel in order to record the sensing data, and therefore this instrument must also experience demanding conditions. Strengthening and ruggedising the sensors as well as the recording medium is straightforward in principle, however an important factor of the sensing solution is that it must impose minimal disturbance to the sailing characteristics of the sail. More precisely, the gains from the sensing solution must outweigh the losses due to its presence on the sail. Therefore, strengthening the sensors simply by adding protection and shields will tend to add weight and bulk, which may not justify the solution.

The second relates to measuring data appropriately so as to glean relevant and repeatable information about the sail. There are a great number of parameters that affect how a sail performs and how it translates into boat speed. Some of these parameters are:
1. Wind speed
2. Wind direction
3. Wind swirls
4. Temperature
5. Temperature gradients
6. Water roughness
7. Water currents
8. Mass of the boat
9. Drag of the boat in the water
10. Drag of the boat in the air

One of the primary problems for a skipper is to interpret both observable and intangible parameters and to trim the boat appropriately, based on his experience. Indeed the key to successfully sailing a boat is often based on “feel”. Although much of sailing is attributed to “feel”, it would be beneficial to ascribe a more rigorous and repeatable method of measuring a sail's characteristics that enhances the boat's performance. It would be impractical and extremely complicated to measure and interpret a complete sensing data set where all of the parameters of the complex sailing dynamics are considered. A more effective approach is to highlight key parameters and to engineer efficient designs that both minimise the number of sensors required on the sail to extract the necessary data.

Optical Sensors, for example Fibre Bragg Grating (FBG) sensors, have been widely deployed to measure the temperature and strain of many civic structures for structural health monitoring, such as buildings, bridges, pipes, dams, ships, and aircraft. In all applications the FBGs are protected due to their fragile nature. FBGs can be embedded directly into a composite structure so that the structure itself provides the protection. Even when embedded, the FBGs are often housed in flexible composite tubes or tape for improved handling. For external use on the surface of structures, they are housed in a protective shield including composite or metal rods, composite or metal plates, and glass tape.

FBGs have been used successfully to measure stress on structures of a yacht, in particular the mast and keel: [1] http://alinghi.epfl.ch/page10243-en.html, [2] “Fibre-sensor specialist breaks the price barrier” Opto & Laser Europe, February 2004, [3] “Optical Fibre Sensors for Structural Part Life Cycle Monitoring”, Pierre Ferdinand, CEA-DETECS, Nantes, 5-6 May 2004, [4] “The use of fibre optic strain monitoring systems in the design, testing and performance monitoring of the novel freestanding Dynarigs on an 87m SuperYacht by Perini Navi”, G. Dijkstra, D. Roberts, International HISWA Symposium on Yacht Design and Yacht Construction, 2004.

Heretofore, no system has been proposed to provide an effective system and method to measure the performance of a sail in real time.

It is therefore an object of this invention to provide an effective method and system in order to provide real-time monitoring of a sail of a sailing vessel to overcome the above mentioned problems.

### SUMMARY OF THE INVENTION

According to the present invention, there is provided, as set out in the appended claims, an optical measurement system for monitoring the condition of a sail, the system comprising an optical interrogation unit that produces and receives an optical signal; and an optical fibre network that interconnects the interrogation unit with a plurality of optical sensors in communication with the sail; wherein the sensors are mounted onto the sail. Ideally, the optical sensors comprise Fibre Bragg Gratings.

The present invention is an optical solution for measuring real-time structural and dynamic conditions of a sail on a sailing vessel, based on Fibre Bragg Gratings (FBG). A real-time optical system measures parameters of the sail, from which shape, integrity and overall conditions of the sail can be calculated.

The invention provides a sensing solution that measures the temperature and strain distributions across a sail in real-time using fibre optics and Fibre Bragg Gratings (FBGs) that overcomes the above mentioned problems. These distributions can then either be used directly, or can be processed further using software models to extract shape and curvature of the sail. This method has advantages over conventional sensing solutions (electronic sensors, photography etc.) in that FBGs are lightweight, extremely sensitive, require low optical power, and can be networked in a fibre optic network consistent with the weave of a racing sail.

Suitably, the sensors can be mounted in rosette configurations. Ideally, the Fibre Bragg Gratings are protected in laminate layers or other flexible material.

In one embodiment the Fibre Bragg Gratings measure temperature and strain of the sail at the location of the sensors. Ideally the shape and/or twist of a sail are calculated from the strain measurements.

Suitably, real-time dynamics of the sail, such as fluttering, ripples and wind swirls, are measured.

Preferably, the Fibre Bragg Gratings can be distributed in a close configuration in order to obtain high spatial resolution measurements in temperature and strain, and from which high-resolution shape and twist measurements can be calculated.

In another embodiment the Fibre Bragg Gratings are distributed over the entire sail surface, and said sail is made from rigid sail materials.

In a further embodiment there is provided matching Fibre Bragg Gratings sensors are placed back-to-back on either side of the sail in order to extract curvature strain from the overall strain measurements.

Suitably, the Fibre Bragg Gratings can be placed along axes of higher strain, including but not limited to the corners, edges and seams of the sail.

Suitably, the sensor response allows the sail to be trimmed in real-time to a specified configuration. It will be appreciated that the invention provides measurements of the dynamics of a sail with real-time measurements of strain and temperature. Examples of dynamic parameters include, but are not limited to: fluttering, reaction to swells, temperature gradients and wind swirls.

In a further embodiment there is provided a method for monitoring the condition of a sail using optical measurement system, the method comprising: providing an optical interrogation unit that produces and receives an optical signal; interconnecting the interrogation unit with a plurality of sensors in communication with the sail to form an optical measurement system; and mounting the sensors are mounted onto the sail.

### BRIEF DESCRIPTION OF DRAWINGS

The invention will be more clearly understood from the following description of an embodiment thereof, given by way of example only, with reference to the accompanying drawings, in which:

FIG. 1 is a schematic of a yacht equipped with an interrogator and sensors according to this invention.

FIG. 2 is a schematic illustrating a typical layout of sensors in a laminate layer.

FIG. 3 illustrates an example of the close-configuration layout of sensors wherein high spatial resolution measurements are obtained.

FIG. 4 is a schematic of the rosette configuration of sensors.

FIG. 5 illustrates an example of a distributed configuration of sensors, which in this case include an arrangement of rosettes.

FIG. 6 illustrates an example of back-to-back arrangement of sensors where in matching pairs of sensors are placed on either side of the sail at the same location.

FIG. 7 illustrates an example of sensor layout wherein the sensors are aligned primarily along the edges, seams and corners of the sail.

### DETAILED DESCRIPTION OF THE DRAWINGS

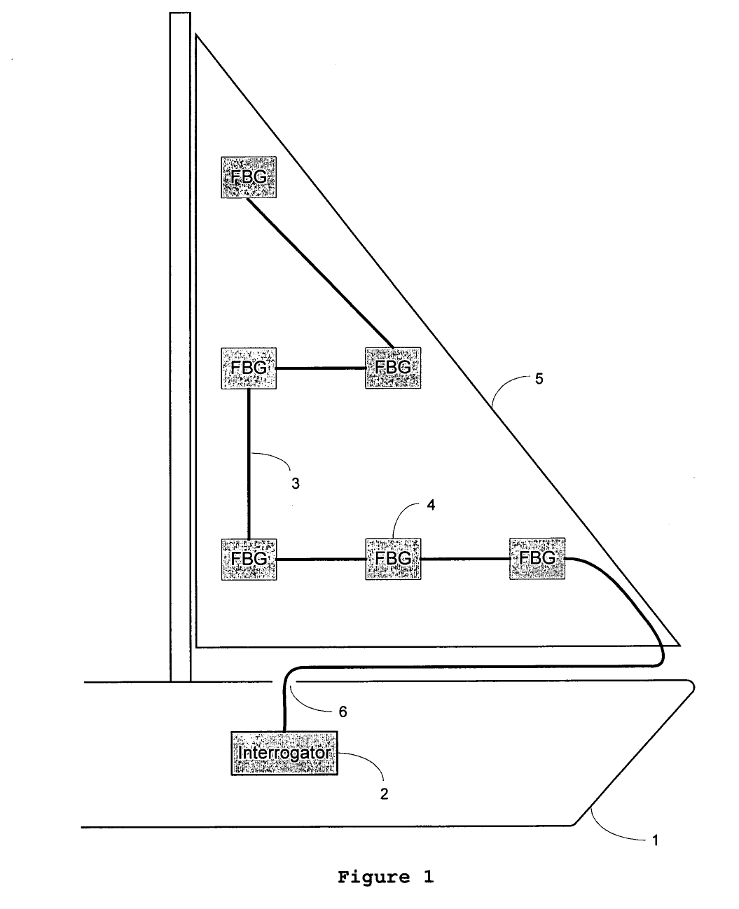

The basic building blocks of the invention are illustrated in FIG. 1. An optical interrogator 2 is installed in a suitable location of the yacht 1 i.e. cabin, from which optical fibre 3 is routed to the optical sensors 4, for example Fibre Bragg Grating (FBG) sensors. The FBG sensors are typically interconnected sequentially, and distributed appropriately, mounted on a sail 5, so as to measure the desired parameters of the sail 5.

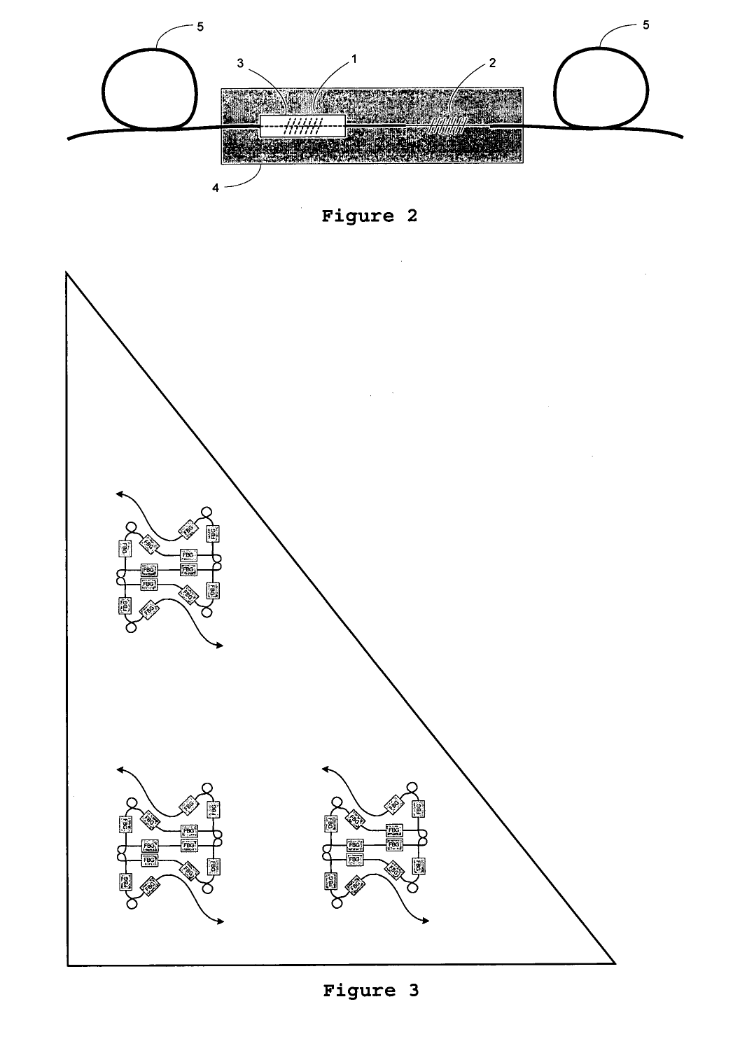

Typically there are two primary types of FBG sensors: “strain” and “temperature” sensors. The fundamental parameters that are measured using FBGs are temperature and strain. In order to correctly extract more complex information from a sail, such as curvature, shape, twist, flapping etc., appropriate distribution and placement of these sensors across the sail 5 is important. The optical response of an FBG is sensitive to both temperature and strain. In order to decouple the two parameters, the “temperature” FBG is housed in such a manner (typically a heat-conducting capillary or tube) that relieves it from any effects of strain so that its response is due solely to temperature. Data from the “temperature” sensors can then be used to decouple strain and temperature measurements from “strain” FBGs, which are subject to both strain and temperature effects. In accordance with the present invention, both “temperature” and “strain” FBGs are housed in laminate layers as is common in commercially available designs. An illustration of such a package is shown in FIG. 2. In this case, both a “temperature” FBG 1 and “strain” FBG 2 are housed in the same laminate layer 4, although they can also be housed separately. The “temperature” FBG is contained within a thin capillary tube 3 to isolate it from strain. The “strain” FBG is mounted directly onto the laminate layers and is therefore exposed to both temperature and strain. The FBGs are connected in series along a fibre optic array 5, and they can be connected sequentially in a chain with other FBG sensors.

The present invention employs FBG sensors 4 and packaged in a flexible laminate layer, for example fibreglass, glass-reinforced plastic (GRP). It is appreciated that this invention is not limited to a specific layer material, and that other flexible materials can be used. The laminate layer offers the toughness and protection needed in order to survive the sailing environment while also ensuring sufficient flexibility to measure strain due to both curvature and axial stretching. The sensors 4 are attached directly to the surface of a sail using adhesive such as water-resistance tape, silicone glue or other water- and salt- resistant, flexible adhesive, and this invention is not limited to the type of adhesive. Polymer compounds that are resistant to water, salt and abrasion protect the optical fibre that interconnects the FBG sensors. One example of fibre protection is 3 mm-diameter PVC sheathed Kevlar. It is appreciated that other types of laminate layers, adhesives and fibre coatings are suitable and can be used for this application.

The optical interrogator 2 can both launch optical signals down the optical fibre 3 and also collect optical data from the FBG sensors 4 along the same fibres. The returned optical signal is converted to electronic data using a suitable optical receiver. The data can then be stored in a memory device, either on the interrogator or separately. Further the data can be processed to extract information about the sail 5 in real-time, that is to say, within the timeframe that a sail can be adjusted. The data can be made available to the skipper for interpretation and subsequent manual adjustment of the sail, or alternatively, the data can be processed using suitable modelling software, and enable automatic adjustment of the sail.

The optical fibre 6 that connects the interrogator to the FBG sensors is routed towards a location of the sail 5 that is normally fixed, usually the tack of a sail 5. For example, in the case of a headsail, the tack is attached to the forestay and is therefore the logical entry point of the fibre onto the sail.

Optical fibre interconnects the FBG sensors, which can be configured in a sequential fashion, as illustrated in FIG. 1, or a distributed star configuration. The preferred configuration may be determined by the desired applications.

The number of sensors and their exact layout is also determined by the desired applications. Examples of these layouts are addressed below. The manner in which the fibre and sensors are mounted onto the sail is of utmost importance, not only for accurate measurements, but also for ruggedness of the optical network against the exposure of the sail.

Close Configuration

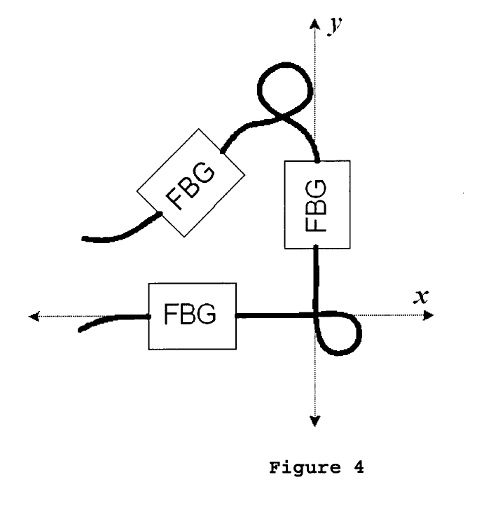

In this configuration, the density of sensors on the sail is high for superior spatial resolution. An example of close configuration on a sail is illustrated in FIG. 3. By placing sensors in close proximity to each other, detailed information on both shape and dynamics of the sail are extracted. High-resolution distribution profiles of strain and temperature can be generated which can then be used to create high-resolution curvature and shape profiles. The sensors are mounted onto the sail in different directions to measure the projection of axial strain across the sail. A preferred arrangement, employed in FIG. 3, is the “rosette” configuration, which is illustrated in FIG. 4. Comprising three “strain” FBGs and at least one “temperature” FBG, the rosette measures orthogonal strain components as well as a diagonal projection (typically 45 degrees), which highlights cross-correlation between the orthogonal axes. On a sail, the two orthogonal axes are chosen to be the horizontal and vertical directions. In addition to the sensors in rosette configurations, other sensors can be mounted in the direction of the seams and edges of the sail.

Distributed Configuration

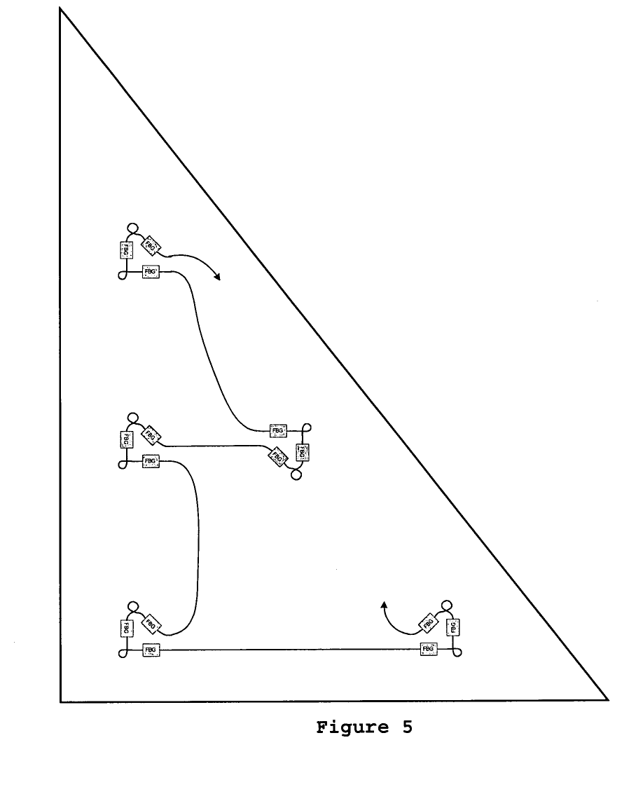

Illustrated in FIG. 5, a distributed configuration covers the entire surface of a sail 5 and generates a broad profile of the sail on a coarser grid than the close configuration. Again, a preferred arrangement is the rosette configuration at each of the distributed measurement points. Alternatively, the sensors can be mounted along seams and edges of the sail as well as in directions of maximum curvature. The distributed configuration is ideal for more rigid sails where the shape does not change as much as a more flexible sail, and where the overall shape can be extrapolated from the localised measurements.

Back-To-Back Configuration

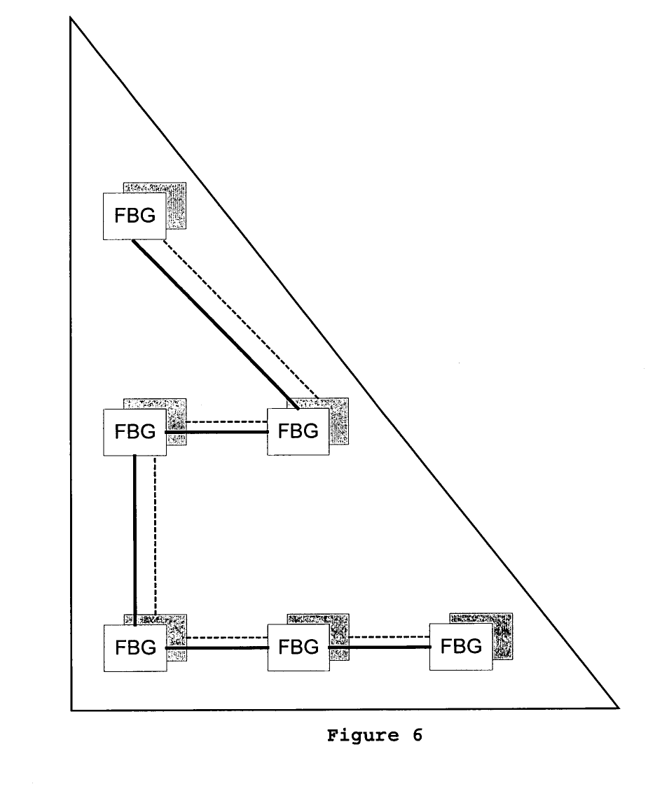

Improved sensitivity in measuring the curvature, and ultimately shape, of the sail is achieved by placing matching sensors back-to-back on either side of the sail, as shown in FIG. 6. Similarly to the distributed and close configurations, a common arrangement is the rosette configuration, although other arrangements are also possible along the edges, seams and directions of maximum curvature.

To a first approximation, neglecting the small differences in the laminate layers, or adhesion to the sail, both matched sensors will experience the same sign and magnitude of axial strain but opposite sign and equal magnitude of curvature strain. This enables curvature and axial strain to be decoupled from each other. Mathematically, this is represented as follows,

Sensor1≅AS 30 CS

Sensor2≅AS−CS

where Sensor1 and Sensor2 are temperature-normalised strain responses, AS is the axial strain and CS is curvature strain. Therefore, CS can be extracted by subtracting the response due to Sensor1 and Sensor2 while AS is calculated by adding Sensor1 and Sensor2:

CS≅(Sensor1−Sensor2)/2

AS≅(Sensor1+Sensor2)/2

Corner, Edge and Seam Configuration

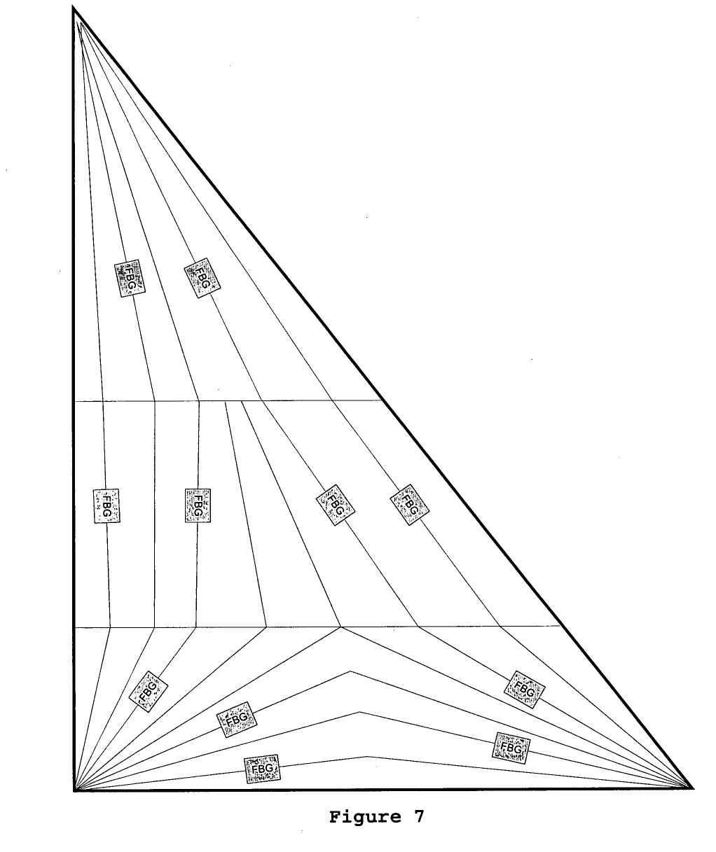

Strain measurements at the corners, edges and seams maximise sensitivity to axial strain. For a given sailing condition, i.e. during individual bearings, the dynamics of the sail can be assumed to be relatively stable. Under these conditions, it is possible to reduce the number of sail parameters to monitor. Highlighting axial strain in this configuration enables a skipper to trim the sail to very exact positions thereby maintaining a more constant force on the sail than would be possible by eye alone. An example of this configuration is shown in FIG. 7. In this example, the sail has a tri-axial design and the FBG sensors are placed along some or all of the seams.

The configurations outlined above are not mutually exclusive. All of the configurations outlined can be achieved simultaneously by employing a comprehensive optical network that includes all of the above layouts.

It will be appreciated that the invention uses Fibre Bragg Gratings appropriately distributed across a sail so as to measure the temperature and strain distributions on the sail. From these parameters, a variety of sail conditions can be inferred in addition to temperature and strain, such as shape, twist, and tightness. It is appreciated that the characteristics and parameters are not limited to the examples listed.

It will be further appreciated that this invention is not limited to the configurations outlined above and that other configurations are possible.

The embodiments in the invention described with reference to the drawings may comprise a computer apparatus and/or processes performed in a computer apparatus to control the optical sensors in conjunction with the optical interrogation unit. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

The invention is not limited to the embodiments hereinbefore described but may be varied in both construction and detail.

1) An optical measurement system for monitoring the condition of a sail, the system comprising:
a) an optical interrogation unit that produces and receives an optical signal; and
b) an optical fibre network that interconnects the optical interrogation unit with a plurality of optical sensors in communication with the sail, wherein the optical sensors are mounted onto the sail.

2) A measurement system as claimed in claim 1 wherein the optical sensors comprise Fibre Bragg Gratings.

3) A measurement system as claimed in claim 1 wherein the optical sensors are mounted in rosette configurations.

4) A measurement system as claimed in claim 2 wherein the Fibre Bragg Gratings are protected in laminate layers or other flexible material.

5) A measurement system as claimed in claim 2 wherein the Fibre Bragg Gratings measure temperature and strain of the sail at the location of the sensors.

6) A measurement system as claimed in claim 5 wherein at least one of shape and twist of the sail are calculated from the measured strain of the sail at the location of the sensors.

7) A measurement system as claimed in claim 1 wherein real-time dynamics of the sail are measured using the optical sensors.

8) A measurement system as claimed in claim 5 where the Fibre Bragg Gratings are distributed in a close configuration in order to obtain high spatial resolution measurements in temperature and strain, and from which high-resolution shape and twist measurements can be calculated.

9) A measurement system as claimed in claim 2 wherein the Fibre Bragg Gratings are distributed over the entire sail surface, and said sail is made from rigid sail materials.

10) A measurement system as in claim 5 wherein matching Fibre Bragg Gratings sensors are placed back-to-back on either side of the sail in order to extract curvature strain from the overall strain measurements.

11) A measurement system as claimed in claim 2 wherein the Fibre Bragg Gratings are placed along axes of higher strain, including but limited to the corners, edges and seams of the sail.

12) A measurement system as claimed in claim 1 wherein sensor response of the optical sensors allows the sail to be trimmed in real-time to a specified configuration.

13) A method for monitoring the condition of a sail using an optical measurement system, the method comprising:
providing an optical interrogation unit that produces and receives an optical signal;
interconnecting the interrogation unit with a plurality of optical sensors, in communication with the sail to form an optical measurement system; and
mounting the sensors onto the sail.

14-15.) (canceled)

16) A computer program for monitoring the condition of a sail using an optical measurement system, wherein the computer program is embodied in a computer readable medium and executable by at least one processor, the computer program comprising:
logic configured to control an optical interrogation unit that produces and receives an optical signal; and
logic configured to control an optical measurement system, wherein the optical measurement system comprises the optical interrogation unit interconnected with a plurality of optical sensors that are mounted to the sail.

17) The computer program of claim 16, further comprising logic to use the optical sensors mounted on the sail to obtain realtime measurements of at least one of sail conditions and sail dynamics.

18) The computer program of claim 17, wherein the optical sensors comprise Fibre Bragg Gratings.

19) The method of claim 7, wherein the real-time dynamics of the sail comprise at least one of fluttering, ripples and wind swirls.
